(19) United States
(12) Patent Application Publication
(10) Pub. No.: US 2019/0276061 A1
(43) Pub. Date: Sep. 12, 2019

(54) CONSTANT MONITORING SYSTEM FOR RAILWAY VEHICLE

(71) Applicant: CENTRAL JAPAN RAILWAY COMPANY, Nagoya-shi (JP)

(72) Inventors: Katsuhisa Hanai, Nagoya-shi (JP); Kazuhiko Nishimura, Nagoya-shi (JP); Masashi Itoyama, Nagoya-shi (JP); Itsuki Yoshida, Nagoya-shi (JP)

(21) Appl. No.: 16/295,336

(22) Filed: Mar. 7, 2019

(30) Foreign Application Priority Data
Mar. 12, 2018 (JP) 2018044231

(51) Int. Cl. B61L 25/02; B61K 9/12; B61L 13/00; B61L 15/00; G01M 17/10

(52) U.S. Cl. CPC B61L 25/028; B61K 9/12; B61D 49/00; B61L 15/0054; G01M 17/10; B61L 13/005

(57) ABSTRACT

Provided is a constant monitoring system for a railway vehicle that is monitorable of a dimensional change of a railroad truck during running. The present disclosure is the constant monitoring system for the railway vehicle that includes a sensor and a calculator. The sensor detects passage therethrough of wheels included in the railroad truck of the railway vehicle. The calculator calculates an inter-axle distance between two axles of the railroad truck based on a detection result obtained from the sensor. The sensor includes two displacement sensors of non-contact type that detect the passage of the wheels from respective different locations.

### CROSS-REFERENCE TO RELATED APPLICATIONS

The present application claims the benefit of Japanese Patent Application No. 2018-44231 filed on Mar. 12, 2018 with the Japan Patent Office, the entire disclosure of which is incorporated herein by reference.

### BACKGROUND

The present disclosure relates to a constant monitoring system for a railway vehicle.

A railroad truck of the railway vehicle is a crucial component that affects vehicle running safety, vehicle running stability, ride comfort, and the like of the railway vehicle. Therefore, dimensional control is executed in assembling the railroad truck. Additionally, the railroad truck is periodically inspected visually or in a non-destructive manner (for example, a magnetic particle flaw inspection or the like) to identify a defect (see, Japanese Unexamined Patent Application Publication No. 2017-9298).

### SUMMARY

A control method using a conventional periodical inspection has difficulty in detecting abnormality in the railroad truck during running until next inspection even if the abnormality occurs with dimensional change of the railroad truck due to damage or the like. Therefore, the abnormality in the railroad truck occurred in an interval between inspections may progress and lead to a serious accident.

In one aspect of the present disclosure, it is desirable to provide a constant monitoring system for a railroad vehicle that can monitor dimensional change of a railroad truck during running.

One aspect of the present disclosure is a constant monitoring system for a railway vehicle that comprises a sensor and a calculator. The sensor detects passage therethrough of wheels included in a railroad truck of the railway vehicle. The calculator calculates an inter-axle distance between two axles of the railroad truck based on a detection result obtained from the sensor. The sensor includes two displacement sensors of non-contact type that detect the passage of the wheels from respective different locations.

Such a configuration enables the sensor to monitor the inter-axle distance of the railroad truck during running even during an interval between periodic inspections. As a result, it is possible to detect degradation in vehicle running safety, vehicle running stability, ride comfort, and the like due to dimensional change of the railroad truck and worsening of the abnormality such as a crack and the like. Additionally, it is possible to seek laborsaving of the periodic inspections by monitoring dimensions of the railroad truck during running.

In one aspect of the present disclosure, the two displacement sensors each may be an optical sensor that is arranged such that an optical axis of the optical sensor crosses an axis that is perpendicular to a running direction of the railroad truck. With such a configuration, it is possible to individually detect passage of two wheels that are individually mounted on both ends of the same axle. As a result, it is possible to both enhance calculation accuracy of the dimensional change of the railroad truck and to determine an inclination direction of each axle.

In one aspect of the present disclosure, the two displacement sensors each may be arranged in a direction in which two or more wheels among the wheels do not concurrently pass on the corresponding optical axis. With such a configuration, it is possible to individually detect a timing of the passage of each wheel. As a result, it is possible to further enhance the calculation accuracy of the dimensional change of the railroad truck.

### BRIEF DESCRIPTION OF THE DRAWINGS

An embodiment of the present disclosure will be described hereinafter by way of example with reference to the drawings, in which:

FIG. 1 is a block diagram schematically showing a configuration of a constant monitoring system for a railway vehicle according to an embodiment;

FIG. 2 is a schematic plan view showing a configuration of a sensor in the constant monitoring system of FIG. 1;

FIG. 3 is one example of an output waveform generated by the sensor of FIG. 2;

FIG. 4 is a schematic plan view showing a configuration of a sensor according to an embodiment that is different from the embodiment in FIG. 2;

FIG. 5 is a schematic plan view showing a configuration of a sensor according to an embodiment that is different from the embodiments in FIGS. 2 and 4; and

FIG. 6 is one example of an output waveform generated by the sensor of FIG. 5.

### DETAILED DESCRIPTION OF THE PREFERRED EMBODIMENTS

### 1. First Embodiment

[1-1. Configuration]

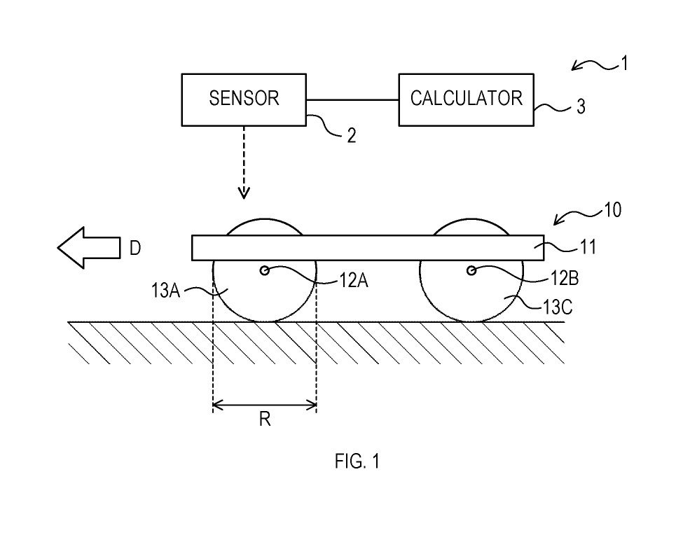

A constant monitoring system 1 for a railway vehicle (hereinafter, simply referred to as a “constant monitoring system” as well) shown in FIG. 1 is a system to monitor dimensions of a railroad truck 10 of the railway vehicle during running. The constant monitoring system 1 comprises a sensor 2 and a calculator 3.

<Railroad Truck>

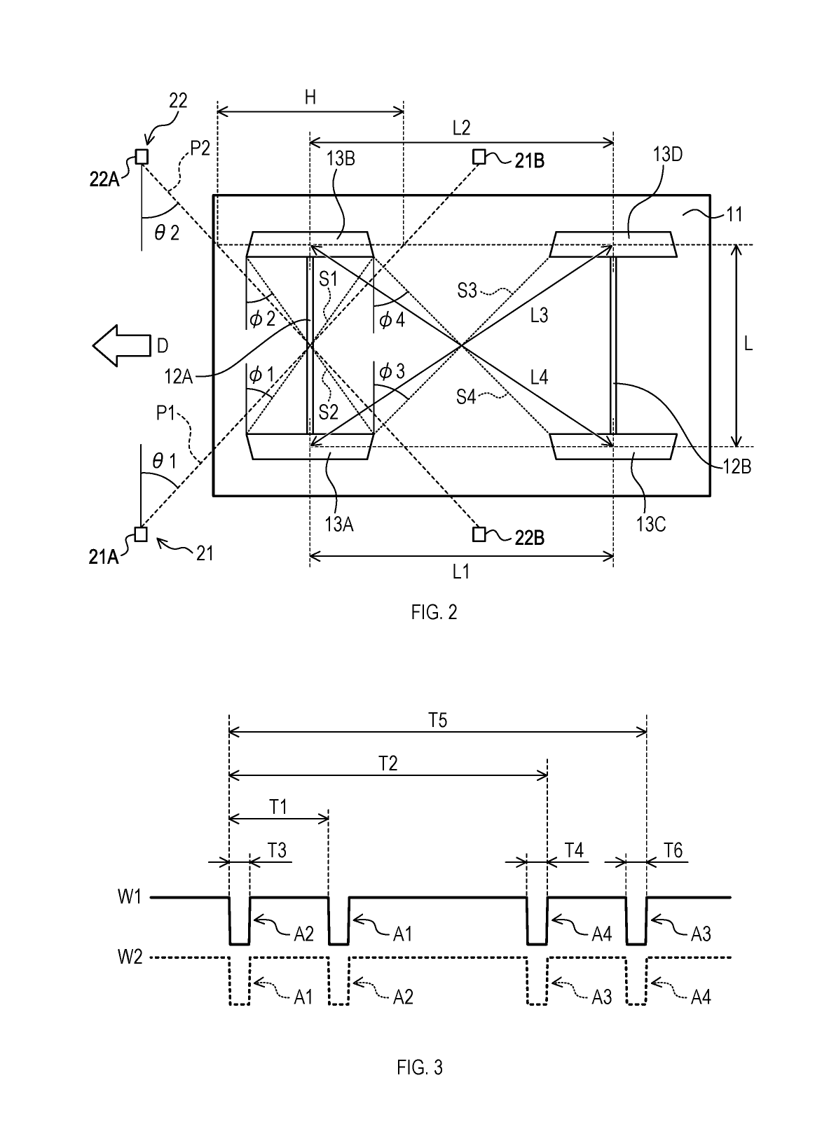

As shown in FIGS. 1 and 2, the railroad truck 10 comprises a frame body 11, a first axle 12A and a second axle 12B, a first wheel 13A, a second wheel 13B, a third wheel 13C, and a fourth wheel 13D.

The first axle 12A is arranged in a frontward side of the railroad truck 10 in a running direction D and is supported by the frame body 11. The first axle 12A includes two ends, on which the first wheel 13A and the second wheel 13B are individually mounted.

The second axle 12B is arranged in a rearward side of the railroad truck 10 in the running direction D, which is distanced from the first axle 12A. The second axle 12B is supported by the frame body 11. The second axle 12B includes two ends, on which the third wheel 13C and the fourth wheel 13D are individually mounted. A length of the second axle 12B equals a length of the first axle 12A.

When the railroad truck 10 is in a normal state (in other words, a state in which there is no abnormality in dimensions), the center axis of the first axle 12A and the center axis of the second axle 12B are perpendicular to the running direction D of the railroad truck 10 (in other words, extending directions of a rail).

<Sensor>

The sensor 2 detects passage therethrough of the wheels 13A, 13B, 13C, and 13D included in the railroad truck 10.

As shown in FIG. 2, the sensor 2 includes two (first and second) displacement sensors 21, 22 of non-contact type. The first displacement sensor 21 and the second displacement sensor 22 detect the passage therethrough of the wheels 13A, 13B, 13C, and 13D from respective different locations.

In the present embodiment, the first displacement sensor 21 and the second displacement sensor 22 each are an optical sensor that includes an optical receiver and an optical emitter. The first displacement sensor 21 irradiates a light ray such as infrared radiation along a straight optical axis P1 from the optical emitter 21A to the optical receiver 21B. The second displacement sensor 22 irradiates a light ray such as infrared radiation along a straight optical axis P2 from the optical emitter 22A to the optical receiver 22B. The first displacement sensor 21 and the second displacement sensor 22 are configured to output a passage signal of an object (in other words, the wheels 13A, 13B, 13C, and 13D) to the calculator 3 in response to the object passing on the optical axis P1 and the optical axis P2.

The first displacement sensor 21 is positioned such that the optical axis P1 crosses an axis that is perpendicular to the running direction D of the railroad truck 10 (hereinafter, also referred to as a “width axis”). Similarly, the second displacement sensor 22 is positioned such that the optical axis P2 crosses the width axis of the railroad truck 10. Here, the width axis of the railroad truck 10 is parallel to longitudinal directions of a sleeper and is parallel to the respective center axes of the first axle 12A and the second axle 12B in the normal state.

The first displacement sensor 21 and the second displacement sensor 22 are arranged in respective directions in which two or more wheels among the wheels 13A, 13B, 13C, and 13D do not concurrently pass on a corresponding one of the optical axis P1 and the optical axis P2 of the first displacement sensor and the second displacement sensor, respectively.

Specifically, an inclination angle θ1 between the optical axis P1 of the first displacement sensor 21 and the width axis of the railroad truck 10 is greater than an inclination angle φ1 between a virtual straight line S1 and the width axis of the railroad truck 10 in the normal state, the virtual straight line S1 connecting a front end of the first wheel 13A and a rear end of the second wheel 13B together.

Additionally, the aforementioned inclination angle θ1 is less than an inclination angle φ3 between a virtual straight line S3 and the width axis of the railroad truck 10, the virtual straight line S3 connecting a rear end of the first wheel 13A and a front end of the fourth wheel 13D together.

Similarly, an inclination angle θ2 between the optical axis P2 of the second displacement sensor 22 and the width axis of the railroad truck 10 is greater than an inclination angle φ2 between a virtual straight line S2 and the width axis of the railroad truck 10 in the normal state, the virtual straight line S2 connecting a front end of the second wheel 13B and the rear end of the first wheel 13A together.

Additionally, the aforementioned inclination angle θ2 is less than an inclination angle φ4 between a virtual straight line S4 and the width axis of the railroad truck 10, the virtual straight line S4 connecting the rear end of the second wheel 13B and a front end of the third wheel 13C together.

Accordingly, the first displacement sensor 21 and the second displacement sensor 22 are arranged so that these sensors can individually detect the passage therethrough of the wheels 13A, 13B, 13C, and 13D (in other words, the front end and the rear end of each wheel) one at a time.

The optical emitter 22A of the second displacement sensor 22 is situated opposite to the optical emitter 21A of the first displacement sensor 21 across the rail on which the railroad truck 10 runs. The optical receiver 22B of the second displacement sensor 22 is situated opposite to the optical receiver 21B of the first displacement sensor 21 across the rail on which the railroad truck 10 runs. Further, the optical axis P1 of the first displacement sensor 21 crosses the optical axis P2 of the second displacement sensor 22.

However, the optical emitter 22A and the optical receiver 22B of the second displacement sensor 22 may not necessarily be situated opposite to the optical emitter 21A and the optical receiver 21B of the first displacement sensor 21. Further, the optical axis P1 of the first displacement sensor 21 may not necessarily cross the optical axis P2 of the second displacement sensor 22. Still further, the optical axis P2 of the second displacement sensor 22 may be in parallel to the optical axis P1 of the first displacement sensor 21.

Here, the optical axis P1 and the optical axis P2 of the first displacement sensor 21 and the second displacement sensor 22, respectively, are preferably horizontal. However, the optical axis P1 and the optical axis P2 may not necessarily be horizontal. Additionally, the optical axis P1 and the optical axis P2 may be at any vertical height that enables the passage of the wheels 13A, 13B, 13C, and 13D thereon. The optical axis P1 and the optical axis P2 may not necessarily be at a height that enables the passage of the axle 12A and the axle 12B thereon.

FIG. 3 shows one example of respective wave forms that are output by the first displacement sensor 21 and the second displacement sensor 22 in response to the passage of the wheels 13A, 13B, 13C, and 13D through the first displacement sensor 21 and the second displacement sensor 22. W1 indicates an output of the first displacement sensor 21 and W2 indicates an output of the second displacement sensor 22.

In FIG. 3, a time elapses from left to right. The wave forms include depressions A1, A2, A3, and A4, respectively, which correspond to the passage of the wheels 13A, 13B, 13C, and 13D.

Accordingly, in the present embodiment, the first displacement sensor 21 detects one wheel of paired two wheels (for example, the second wheel 13B) mounted on the same axle (for example, the first axle 12A) with the second displacement sensor 22 concurrently detecting the other wheel of the paired two wheels (for example, the first wheel 13A).

Therefore, if the first displacement sensor 21 and the second displacement sensor 22 individually detect the paired wheels at a coincident detection time (for example, A2 of W1 and A1 of W2 in FIG. 3), determination can be made that the railroad truck 10 is placed in the normal state, where each axle is not inclined relative to the width axis.

In contrast, if the first displacement sensor 21 and the second displacement sensor 22 detect the paired wheels at respective different detection times with a delay therebetween, determination can be made that each axle is inclined relative to the width axis. Additionally, an inclination direction of each axle (in other words, a wheel of the paired wheels that is inclined frontward) can be determined in accordance with which one precedes the other between a detection time of the first displacement sensor 21 and a detection time of the second displacement sensor 22.

The aforementioned determination in respect of inclination can be made for each axle. Therefore, it is possible to determine cases, such as where only one of the first axle 12A or the second axle 12B is inclined; the first axle 12A and the second axle 12B are inclined in the same direction; and the first axle 12A and the second axle 12B are inclined in respective different directions.

<Calculator>

The calculator 3 calculates a distance between the two axles of the railroad truck 10 based on a detection result obtained from the sensor 2. The calculator 3 is configured with a computer that comprises an inputter and an outputter, for example.

The calculator 3 calculates inter-axle distances L1, L2, L3, and L4 shown in FIG. 2. Specifically, the inter-axle distance L1 is a distance along the running direction D between the first wheel 13A and the third wheel 13C. The inter-axle distance L2 is a distance along the running direction D between the second wheel 13B and the fourth wheel 13D. The inter-axle distance L3 is a diagonal distance between the center of the first wheel 13A and the center of the fourth wheel 13D. The inter-axle distance L4 is a diagonal distance between the center of the second wheel 13B and the center of the third wheel 13C.

For example, the inter-axle distances L1, L2, L3, and L4 can be calculated through the following procedures. First, a velocity V of the railroad truck 10 is obtained through the following formula (1).

V=H/T1 (1)

In the aforementioned formula (1), H is a distance along the running direction D of the railroad truck 10 between a wheel location detected by the first displacement sensor 21 and a wheel location detected by the second displacement sensor 22. As shown in FIG. 3, T1 is a time duration from a time when the first displacement sensor 21 detects passage therethrough of one wheel to a time when the second displacement sensor 22 detects the passage therethrough of the same wheel. T1 may be based on a detection result of one wheel or based on an average value obtained among detection results of two or more wheels.

The aforementioned inter-axle distance L2 is obtained through the following formula (2), for example.

L2=V×(T2−(T3+T4)/2) (2)

As shown in FIG. 3, T2 in the aforementioned formula (2) is a time duration from a time when the first displacement sensor 21 initiates detecting the passage of the second wheel 13B mounted on the first axle 12A to a time when the first displacement sensor 21 completes detecting the passage of the fourth wheel 13D mounted on the second axle 12B. Further, T3 is a passage time duration of the second wheel 13B and T4 is a passage time duration of the fourth wheel 13D.

The aforementioned inter-axle distance L4 can be obtained through the following formula (3), for example.

L4=((V×(T5−(T3+T6)/2)−H)²+L²)^{0.5} (3)

As shown in FIG. 3, T5 in the aforementioned formula (3) is a time duration from a time when the first displacement sensor 21 initiates detecting the passage of the second wheel 13B mounted on the first axle 12A to a time when the first displacement sensor 21 completes detecting the passage of the third wheel 13C mounted on the second axle 12B. Further, T6 is a passage time duration of the third wheel 13C and L is a distance between a first contact point and a second contact point. In the first contact point, the first wheel 13A is in contact with the rail. In the second contact point, the second wheel 13B is in contact with the rail.

The inter-axle distance L1 can be obtained through a similar procedure as with the aforementioned inter-axle distance L2. The inter-axle distance L3 can be obtained through a similar procedure as with the aforementioned inter-axle distance L4.

Additionally, the calculator 3 calculates a wheel radius R of each wheel. The wheel radius R is obtained through a geometric calculation. In the geometric calculation, a mounting height of each of the first displacement sensor 21 and the second displacement sensor 22 (in other words, a vertical distance from each axle on which the wheel is mounted) is taken into consideration for a wheel detection width obtained from the passage time duration of each wheel and the velocity V of the railroad truck 10.

The calculator 3 includes a function to notify that the inter-axle distances exceed a threshold value upon occurrence of such excess. A notifying method includes displaying a warning or other notices on a control system situated in and/or outside the railway vehicle through an operation system of the railway vehicle, to which the calculator 3 is connected. With this, a defect of the railroad truck 10 can be detected at an early stage of the defect and can be handled promptly.

[1-2. Effects]

According to the above-detailed embodiment, the following effects can be obtained.

(1a) The sensor 2 enables monitoring of the inter-axle distances of the railroad truck 10 during running even during an interval between periodic inspections. Therefore, it is possible to detect degradation in vehicle running safety, vehicle running stability, ride comfort, and the like due to dimensional change of the railroad truck 10 and worsening of the abnormality such as a crack and the like. Additionally, the constant monitoring system 1 monitors the dimensions of the railroad truck 10 during running, to thereby seek laborsaving of the periodic inspections.

(1b) The first displacement sensor 21 and the second displacement sensor 22, respectively, are arranged such that the optical axis P1 and the optical axis P2 thereof cross the axis that is perpendicular to the running direction D of the railroad truck 10. Therefore, the two wheels individually mounted on both ends of the same axle can be detected individually and separately. Consequently, it is possible to both enhance calculation accuracy of the dimensional change of the railroad truck 10 and to determine the inclination direction of each axle.

(1c) The first displacement sensor 21 and the second displacement sensor 22 are arranged in the respective directions in which the two or more wheels among the wheels 13A, 13B, 13C, and 13D do not concurrently pass on the corresponding one of the optical axis P1 and the optical axis P1. Therefore, it is possible to individually detect a timing of the passage of each wheel. Consequently, it is possible to further enhance the calculation accuracy of the dimensional change of the railroad truck 10.

### 2. Other Embodiments

The embodiment of the present disclosure has been described above. However, the present disclosure is not limited to the above-described embodiment and can be modified variously.

(2a) In the constant monitoring system 1 of the above-described embodiment, the first displacement sensor 21 and the second displacement sensor 22 may not necessarily be arranged in the respective directions in which the two or more wheels among the wheels 13A, 13B, 13C, and 13D do not concurrently pass on each of the optical axis P1 and the optical axis P2.

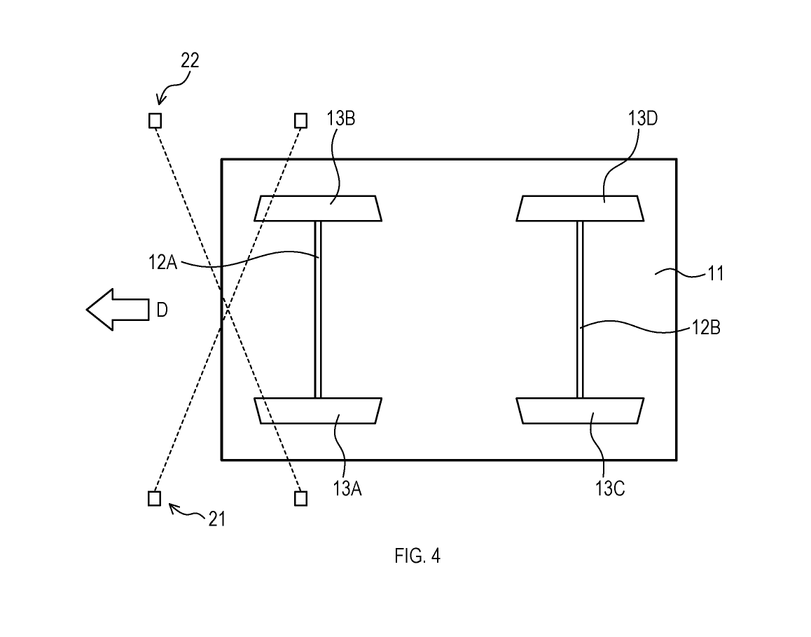

In other words, as shown in FIG. 4, the first displacement sensor 21 and the second displacement sensor 22 may be arranged such that the wheel 13 B and the wheel 13A mounted on the first axle 12A concurrently pass on the optical axis P1 and the optical axis P2, respectively. Even with this arrangement, it is possible to determine whether each axle is inclined and to calculate the inter-axle distances.

(2b) In the constant monitoring system 1 of the above-described embodiment, the first displacement sensor 21 and the second displacement sensor 22 may not necessarily be arranged such that the optical axis P1 and the optical axis P2 cross the axis that is perpendicular to the running direction D of the railroad truck 10.

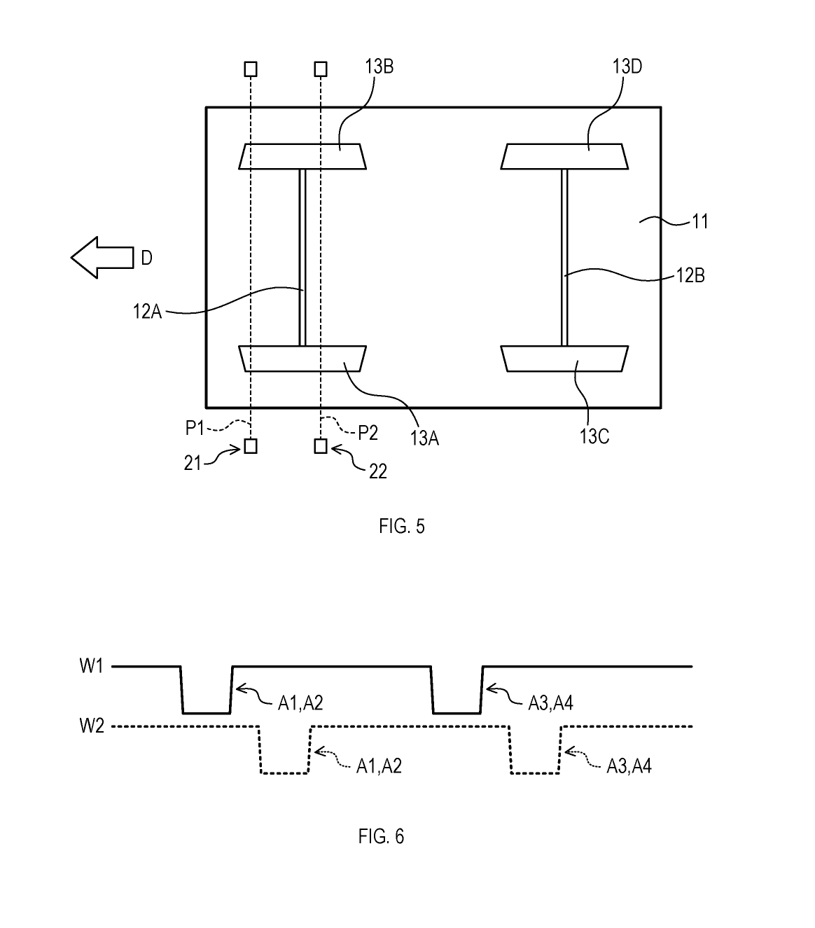

For example, as shown in FIG. 5, the first displacement sensor 21 and the second displacement sensor 22 may be arranged such that the optical axis P1 and the optical axis P2 cross the axis that is are perpendicular to the running direction D of the railroad truck 10. Even with this arrangement, it is possible to calculate the inter-axle distances.

According to this arrangement, as shown in FIG. 6, the passage of the first wheel 13A and the second wheel 13B are concurrently detected in each of the output W1 of the first displacement sensor 21 and in the output W2 of the second displacement sensor 22. In other words, the depressions A1, A2 in the output W1 and the output W2 indicate the passage of the first wheel 13A and the second wheel 13B on each axle together. Similarly, the passage of the third wheel 13C and the fourth wheel 13D on each axle is detected concurrently.

Additionally, the first displacement sensor 21 and the second displacement sensor 22 each can be replaced for use with a displacement sensor of non-contact type other than the optical sensor. Such a displacement sensor of non-contact type includes an ultrasound sensor, for example.

The ultrasound sensor used as the first displacement sensor 21 and the second displacement sensor 22 is configured to transmit an ultrasound wave in a vertical direction that is perpendicular to the running direction D of the railroad truck 10 and to receive a reflected ultrasound wave on each wheel, to thereby detect the passage of each wheel.

(2c) A function achieved by one element in the aforementioned embodiment may be divided into two or more elements. A function achieved by two or more elements may be integrated into one element. Further, a part of the configuration of the aforementioned embodiment may be omitted. At least a part of the configuration of the aforementioned embodiment may be added to or replaced with the configuration of the aforementioned other embodiments. It should be noted that any and all modes that are encompassed in the technical ideas defined by the languages in the scope of the claims are embodiments of the present disclosure.

What is claimed is:

1. A constant monitoring system for a railway vehicle, comprising:
a sensor detecting passage therethrough of wheels included in a railroad truck of the railway vehicle; and
a calculator calculating an inter-axle distance between two axles of the railroad truck based on a detection result obtained from the sensor,
wherein the sensor includes two displacement sensors of non-contact type that detect the passage of the wheels from respective different locations.

2. The constant monitoring system for the railway vehicle according to claim 1,
wherein the two displacement sensors each are an optical sensor that is arranged such that an optical axis of the optical sensor crosses an axis that is perpendicular to a running direction of the railroad truck.

3. The constant monitoring system for the railway vehicle according to claim 2,
wherein the two displacement sensors each are arranged in a direction in which two or more wheels among the wheels do not concurrently pass on the corresponding optical axis.
